(19) United States
(12) Patent Application Publication
(10) Pub. No.: US 2024/0004593 A1
(43) Pub. Date: Jan. 4, 2024

(54) IMAGE PROCESSING DEVICE, AND NON-TRANSITORY COMPUTER-READABLE RECORDING MEDIUM THEREFOR

(71) Applicant: BROTHER KOGYO KABUSHIKI KAISHA, Nagoya (JP)

(72) Inventors: Yoichi SHIKAI, Nagoya (JP); Masaki KONDO, Toyoake (JP); Kentaro SAWANO, Nagoya (JP); Kohei WATANABE, Nagoya (JP); Takaaki MASUDA, Ogaki (JP); Masayoshi MITA, Nagoya (JP)

(21) Appl. No.: 18/345,579

(22) Filed: Jun. 30, 2023

(30) Foreign Application Priority Data
Jul. 1, 2022 (JP) 2022-107392

(51) Int. Cl. G06F 3/12; G06K 15/02

(52) U.S. Cl. CPC G06F 3/1208; G06F 3/1242; G06F 3/1253; G06K 15/1885

(57) ABSTRACT

An image processing device performs, multiple times a candidate displaying process of displaying one or more candidate images on a display, each of the one or more candidate images being a candidate of the print image, and an evaluation obtaining process of obtaining image evaluation information representing evaluation of each of the one or more candidate images displayed on the display, the image evaluation information being information based on a user input. In the candidate displaying process performed a second time or later is a process of determining the one or more candidate images based on the image evaluation information and displaying the same on the display. The image processing device determines the print image based on at least part of a multiple candidate images and at least part of multiple pieces of the image evaluation information.

### REFERENCE TO RELATED APPLICATIONS

This application claims priority from Japanese Patent Application No. 2022-107392 filed on Jul. 1, 2022. The entire content of the priority application is incorporated herein by reference.

### BACKGROUND ART

The present disclosures related to a technique of determining an image to be printed, and causing a print engine to print the determined image.

Printing is performed using various products as printing media. For example, there has been known an inkjet printer configured to perform printing on an elastic T-shirt with holding the same between two films.

### DESCRIPTION

When the printing is to be performed, there is a case where a user of the printer has a difficulty in preparing an image to be printed. Therefore, there has been a demand for a simple way to determine the print image that matches the user's preferences based on the user's input and have the print engine print the same.

According to aspects of the present disclosures, there is provided a non-transitory computer-readable recording medium for an image processing device which includes a computer, the non-transitory computer-readable recording medium containing computer-executable instructions. The instructions causes, when executed by the computer, the image processing device to perform a print image determining process of determining a print image to be printed, a print data generating process of generating print data indicating the determined print image, and a print controlling process of causing a print engine to execute printing according to the print data. In the print image determining process, the image processing device performs, multiple times a candidate displaying process of displaying one or more candidate images on a display, each of the one or more candidate images being a candidate of the print image, and an evaluation obtaining process of obtaining image evaluation information representing evaluation of each of the one or more candidate images displayed on the display, the image evaluation information being information based on a user input. The candidate displaying process performed a second time or later is a process of determining the one or more candidate images based on the image evaluation information and displaying the determined one or more candidate images on the display. The print image determining process determines the print image based on at least part of multiple candidate images displayed in the candidate displaying process performed over multiple times and at least part of multiple pieces of the image evaluation information obtained in the evaluation obtaining process performed over multiple times.

According to aspects of the present disclosures, there is provided an image processing device includes a print engine configured to print an image, and a controller configured to perform a print image determining process of determining a print image to be printed, a print data generating process of generating print data indicating the determined print image, and a print controlling process of causing the print engine to execute printing according to the print data. In the print image determining process, the controller performs, multiple times, a candidate displaying process of displaying one or more candidate images on a display, each of the one or more candidate images being a candidate of the print image, and an evaluation obtaining process of obtaining image evaluation information representing evaluation of each of the one or more candidate images displayed on the display, the image evaluation information being information based on a user input. The candidate displaying process performed a second time or later is a process of determining the one or more candidate images based on the image evaluation information and displaying the determined one or more candidate images on the display. The print image determining process, the controller determines the print image based on at least part of multiple candidate images displayed in the candidate displaying process performed over multiple times and at least part of multiple pieces of the image evaluation information obtained in the evaluation obtaining process performed over multiple times.

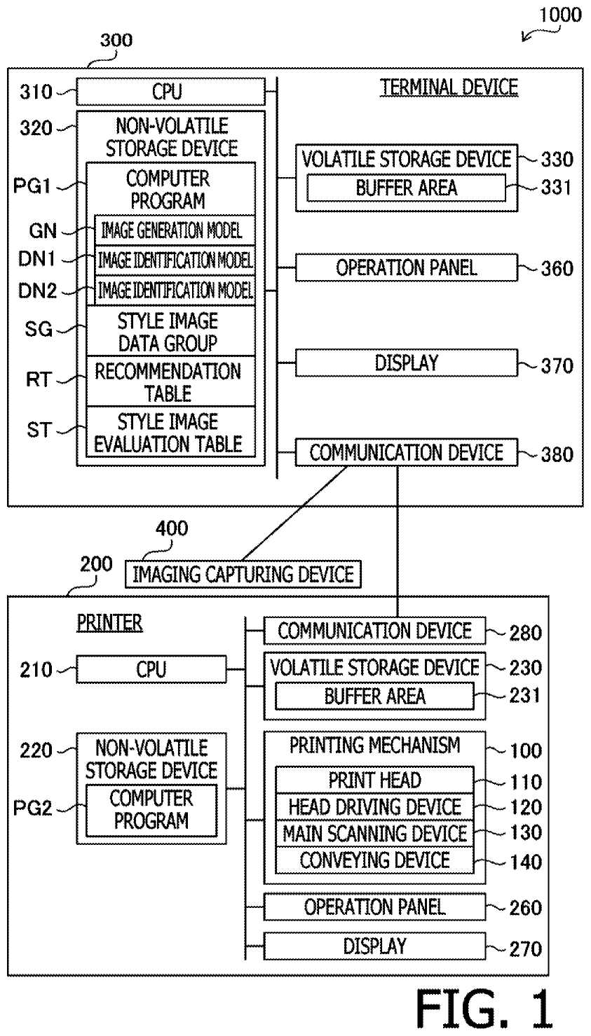

FIG. 1 is a block diagram showing a configuration of a print system according to an embodiment of the present disclosures.

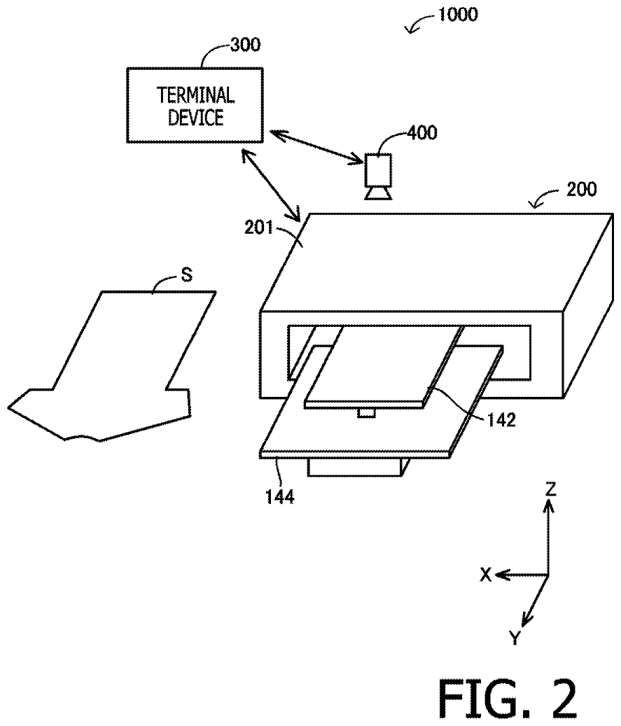

FIG. 2 is a perspective view schematically showing a structure of the print system.

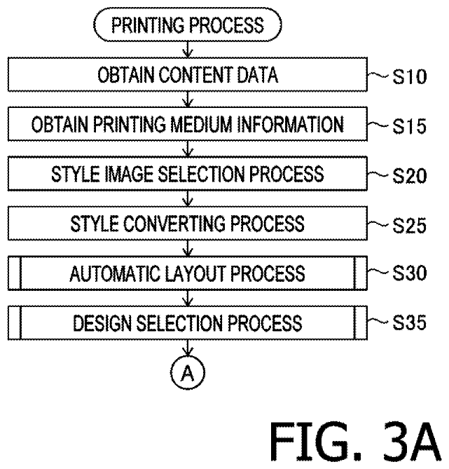

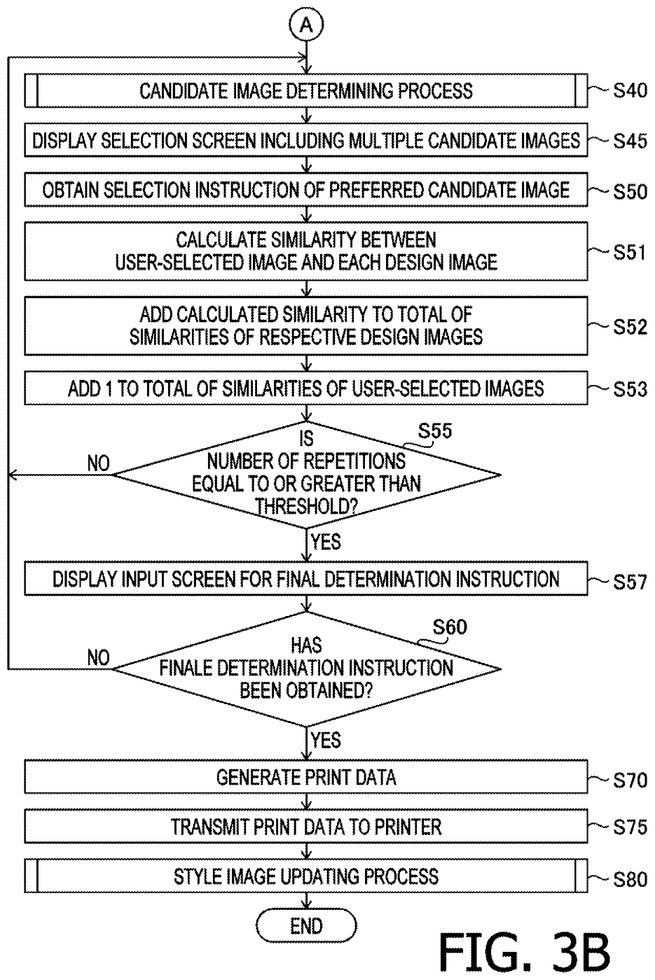

FIGS. 3A and 3B are a flowchart illustrating a printing process.

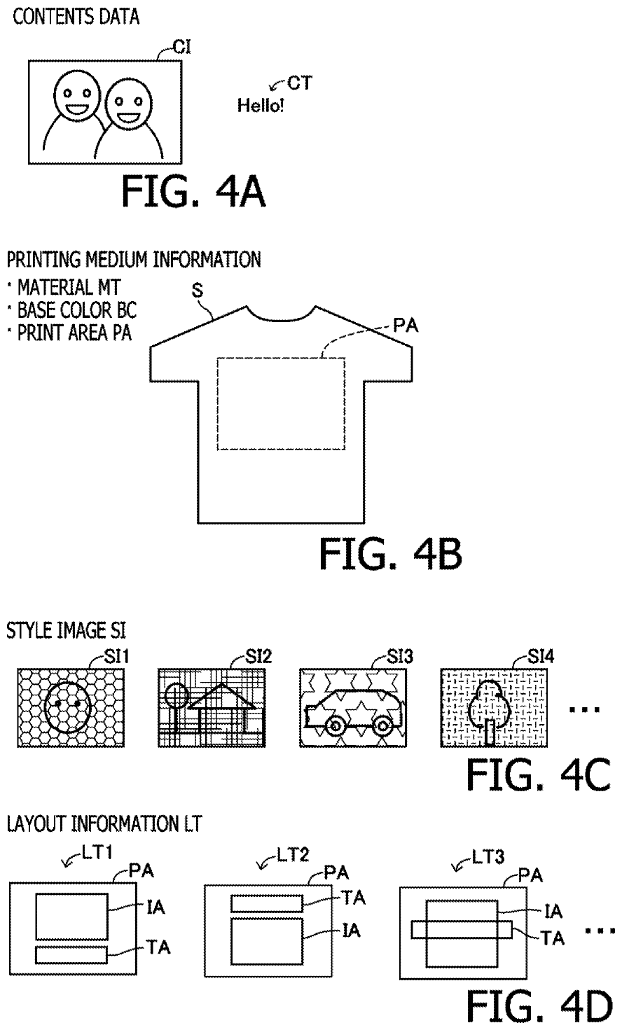

FIGS. 4A-4D show examples of data used for the printing process.

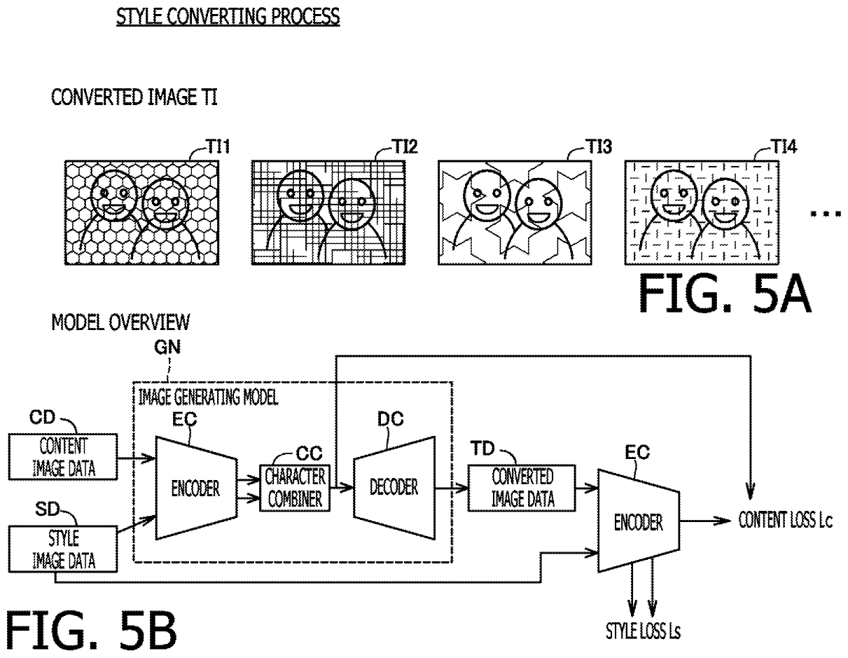

FIGS. 5A and 5B illustrate a style converting process.

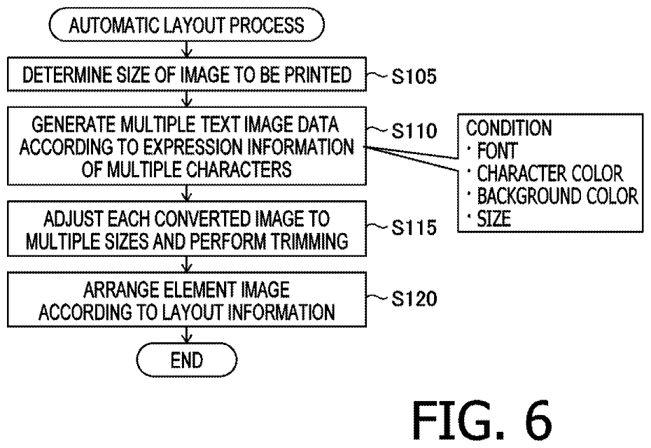

FIG. 6 is a flowchart illustrating an automatic layout process.

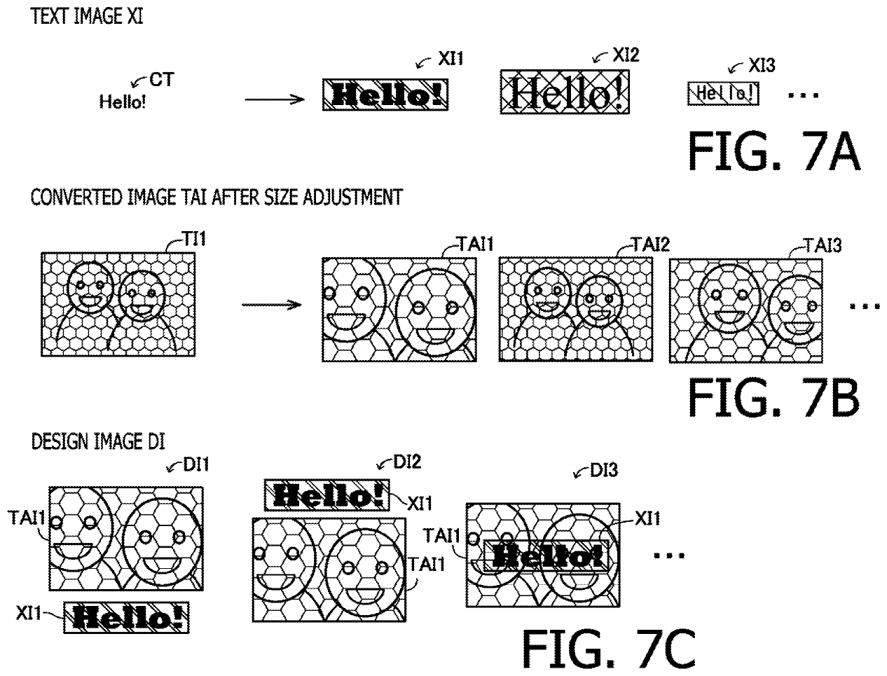

FIGS. 7A-7C illustrate the automatic layout process.

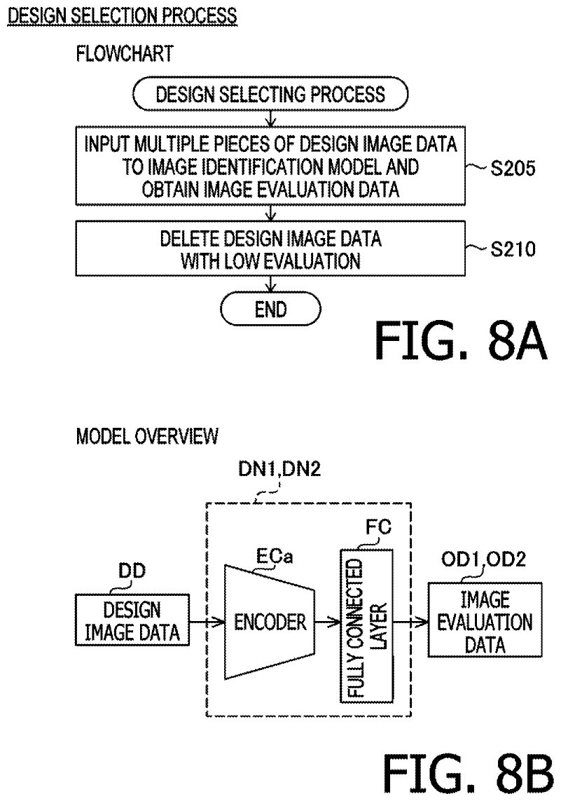

FIGS. 8A and 8B illustrate a design selecting process.

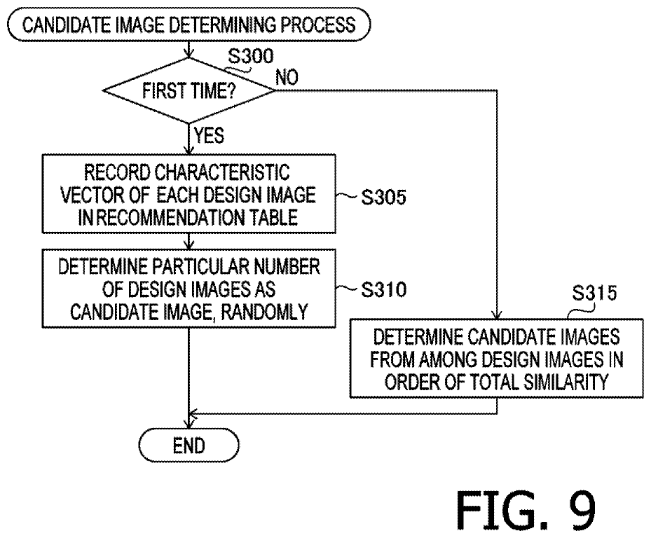

FIG. 9 is a flowchart illustrating a candidate image determining process.

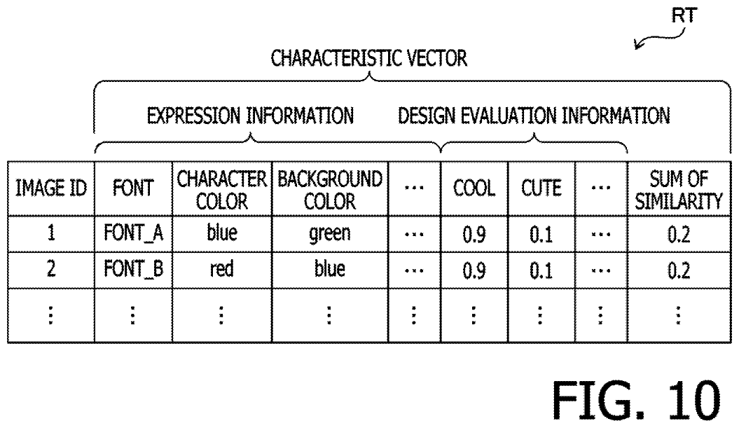

FIG. 10 shows an example of a recommended table.

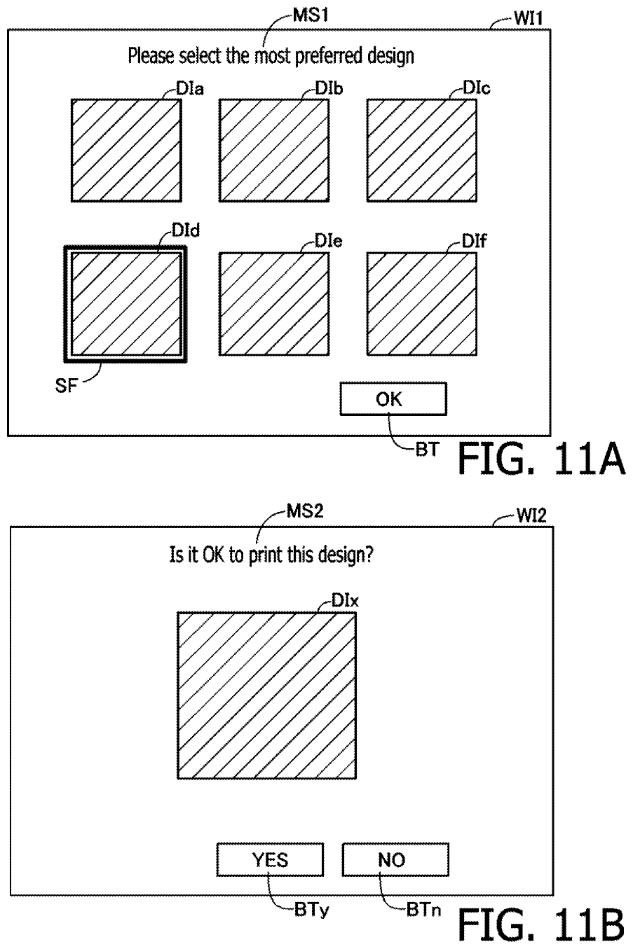

FIGS. 11A and 11B show examples of a UI screen.

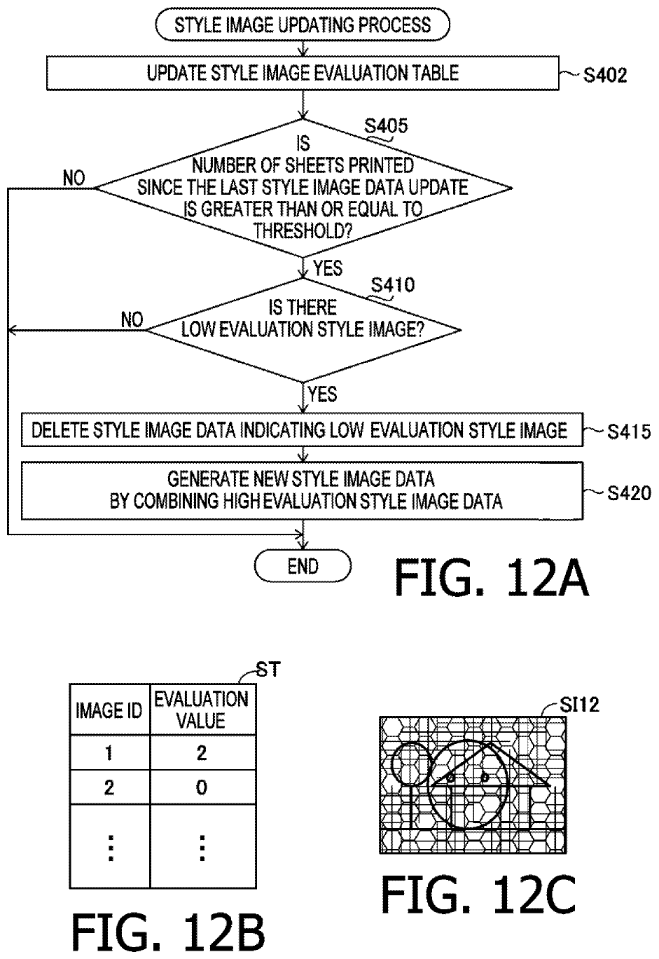

FIGS. 12A-12C illustrate a style image updating process according to an embodiment.

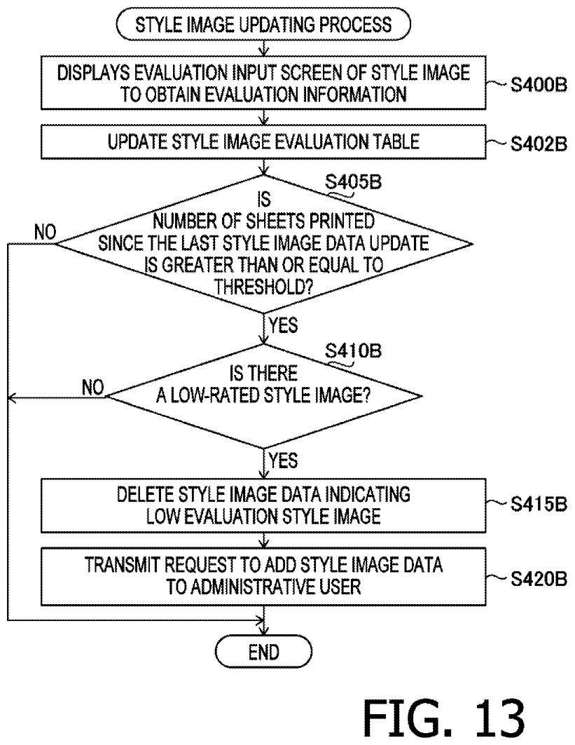

FIG. 13 is a flowchart illustrating a style image updating process according to a modified embodiment.

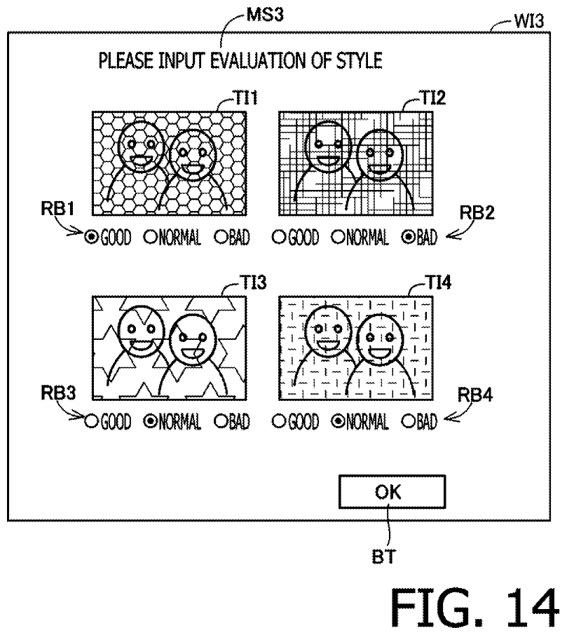

FIG. 14 shows an example of an evaluation input screen WI3.

Hereinafter, a print system 1000 according to an embodiment will be described with reference to the accompanying drawings. FIG. 1 is a block diagram showing a configuration of the print system 1000. The print system 1000 includes a printer 200, a terminal device 300, which is an image processing device according to the embodiment, and an image capturing device 400. The printer 200 and the terminal device 300 are communicably connected, and the image capturing device 400 and the terminal device 300 are communicably connected.

The terminal device 300 is a computer used by a user of the printer 200, which is, for example, a personal computer or a smartphone. The terminal device 300 has a CPU 310 as a controller of the terminal device 300, a non-volatile storage device 320 such as a hard disk drive, a volatile storage device 330 such as a RAM, an operation device 360 such as a mouse or keyboard, a display 370 such as a liquid crystal display, and a communication interface 380. The communication interface 380 includes a wired or wireless interface for communicatively connecting to external devices, e.g., the printer 200 and the image capturing device 400.

The volatile storage device 330 provides a buffer area 331 to temporarily store various intermediate data generated by the CPU 310 during processing. The non-volatile storage device 320 contains a computer program PG1, a group of style image data SG, a recommendation table RT, and a style image evaluation table ST. The computer program PG1 is provided by the manufacturer of the printer 200, in the form, for example, of a download from a server or embodiment stored on a DVD-ROM or the like. The CPU 310 functions as a printer driver that controls the printer 200 by executing the computer program PG1. The CPU 310 as a printer driver executes, for example, a printing process described below. A style image data group SG contains multiple pieces of style image data.

The computer program PG1 contains a program causing the CPU 310 to realize an image generation model GN and image identification models DN1 and DN2 (described later) as a program module. The style image data group SG, the recommendation table RT and the style image evaluation table ST will be described later when the printing process is described in detail.

The image capturing device 400 is a digital camera configured to generate image data (also referred to as captured image data) representing an object by optically capturing (photographing) the object. The image capturing device 400 is configured to generate the captured image data in accordance with the control by the terminal device 300 and transmit the same to the terminal device 300.

The printer 200 includes a printing mechanism 100, a CPU 210 serving as a controller of the printer 200, a non-volatile storage device 220 such as a hard disk drive, a volatile storage device 230 such as a RAM, an operation panel 260 including buttons and/or a touch panel to obtain operations by a user, a display 270 such as a liquid crystal display, and a communication interface 280. The communication interface 280 includes a wireless or wired interface for communicably connecting the printer 200 with external devices such as the terminal device 300.

The volatile storage device 230 provides a buffer area 231 for temporarily storing various intermediate data which are generated when the CPU 210 performs various processes. The non-volatile storage device 220 stores a computer program PG2. The computer program PG2 according to the present embodiment is a controlling program for controlling the printer 200, and could be provided as stored in the non-volatile storage device 220 when the printer is shipped. Alternatively, the computer program PG2 may be provided in a form of being downloadable from a server, or in a form of being stored in a DVD-ROM or the like. The CPU 210 is configured to print images on a printing medium by controlling the printing mechanism 100 in accordance with the print data transmitted from the terminal device 300 in the printing process (described later). It is noted that, in the present embodiment, clothes are assumed to be the printing medium, and the printer 200 according to the present embodiment is configured to print images on clothes S such as a T-shirt (see FIG. 2).

The printing mechanism 100 is a printing mechanism employing in inkjet printing method, and is configured to eject ink droplets of C (cyan), M (magenta), Y (yellow) and K (black) onto the printing medium. The printing mechanism 100 includes a print head 110, a head driving device 120, a main scanning device 130 and a conveying device 140.

FIG. 2 is a perspective view schematically showing a structure of the print system 1000. In FIG. 2, +X, −X, +Y, −Y, +Z, and −Z directions in FIG. 2 are left, right, front, back, up, and down sides of the printer 200 respectively. Here, the +X direction is the direction indicated by arrow X, the −X direction is the direction opposite to that indicated by arrow X, the +Y direction is the direction indicated by arrow Y, the −Y direction is the direction opposite to that indicated by arrow Y, and the +Z direction is the direction indicated by arrow Z, the −Z direction is the direction opposite to that indicated by arrow Z.

The main scanning device 130 is configured in such a manner that a well-known carriage (not shown/well-known) mounting the print head 110 is reciprocally move in a main scanning direction (i.e., the X direction in FIG. 2) with use of a driving forth of a well-known main scanning motor (not shown/well-known) inside a casing 201 of the main scanning device 130. In this way, a main scanning, that is, a reciprocal movement of the print head 110 in the main scanning direction (i.e., the X direction) relative to the printing medium such as the clothes S is realized.

The conveying device 140 has a platen 142 and a tray 144 which are arranged at a central area, in the X direction, of the casing 201. The platen 142 is a plate-like member and an upper surface thereof (i.e., a surface on the +Z side) of the platen 142 is a placing surface on which the printing medium such as the clothes S is to be placed. The platen 142 is secured onto the tray 144, which is plate-like member, arranged on the —Z direction with respect to the platen 142. The tray 144 is one size larger than the platen 142. The platen 142 and the tray 144 hold the printing medium such as the clothes S. The platen 142 and the tray 144 are conveyed in a conveying direction (the Y direction in FIG. 2) crossing perpendicular to the main scanning direction, by a driving force of a well-known sub scanning motor (not shown/well-known). In this way, the sub scanning, or conveying of the printing medium such as the cloth S in the conveying direction with respect to the print head 110 is realized.

The head driving device 120 (see FIG. 1) drives the print head by supplying a drive signal to the print head 110 when the main scanning device 130 is performing the main scanning of the print head 110. The print head 110 has well-known multiple nozzles (not shown/well-known), and controlled by the drive signal to eject ink droplets, through the multiple nozzles, on the printing medium, which is conveyed by the conveying device 140, to form a dot image thereon.

As shown in FIG. 2, the image capturing device 400 is arranged on the +Z direction with respect to the printer 200 by being supported by a well-known supporting member (not shown/well-known). The image capturing device 400 is arranged to be spaced from the printer 200, and to face an upper surface (i.e., the placing surface) of the platen 142 so as to capture an image of the printing device such as the clothes S placed on the upper surface of the platen 142. In this way, the image capturing device 400 is capable of generate captured image data representing an image containing the printing medium such as the clothes S.

The print system 1000 is configured to print a particular print image (e.g., a pattern, a logo and the like) in a print area, which is a partial area of the clothes S as the printing medium. In the present embodiment, as shown in FIG. 2, the clothes S is a T-shirt and the print area is an area corresponding to a wearer's chest. The print system 1000 is installed, for example, at a shop selling where T-shirts are sold. The print system 1000 is managed, for example, by a salesperson in the shop. As will be described later, the print system 1000 operates as the terminal device 300 is operated by customers or salespersons of the shop operate the terminal device 300 to use the print system 1000. As above, the users of the print system 1000 are, for example, the customers and/or the salespersons of the shop.

The CPU 310 of the terminal device 300 is configured to perform a printing process. The printing process is a process of printing print images on the clothes S with use of the printer 200. FIGS. 3A and 3B are a flowchart illustrating the printing process. The printing process is started when, for example, the clothes S, which is the printing medium, is placed on the platen 142, and the user (e.g., a customer of the shop) inputs a start command into the terminal device 300 in a state where the image capturing device 400 can capture an image of the clothes S placed on the platen 142 from the above.

In S10, the CPU 310 obtains content data, and stores the same in a memory (e.g., the non-volatile storage device 320 or the volatile storage device 330). FIG. 4A illustrate an example of the content data. The content data includes content image data representing an image CI as the content (hereinafter, also referred to as a content image), and text data representing a text CT as the content. The content image data may be, for example, captured image data that is generated by capturing an image of an object with use of a digital camera, or image data representing a computer graphic such as an illustration. The content image data is bitmap data representing an image having a plurality of pixels. Concretely, the content image data may be RGB image data indicating a color of each pixel by RGB values. According to the present embodiment, the content data include one piece of image data and one piece of text data. In an modification, the content data may include multiple pieces of image data and/or multiple pieces of text data.

The content data is prepared by the user. For example, when a customer of the shop is the user, the user may visit the shop with the content data being stored in a customer's smartphone. At the shop, the customer may connect the smartphone with the terminal device 300 via the wired or wireless communication interface. When connected, Then, the CPU 310 obtains the content data designated by the customer from the customer's smartphone.

In S15, the CPU 310 obtains printing medium information (see FIG. 4B). The printing medium information is information regarding the clothes S as the printing medium. The printing medium information indicates, for example, the material MT of the clothes, a base color BC of fabric, and a print area PA. The print area PA is, for example, an area of the clothes S corresponding to a chest portion thereof. The CPU 310 displays a well-known UI (user interface) screen (not shown/conventionally known) on the display 370, and obtains the printing medium information input by the user via the UI screen. Information indicating the print area PA is obtained, for example, as the user designates a rectangular print area PA (see FIG. 4B) on the UI screen including an image of the clothes S captured by the image capturing device 400. In S20, the CPU 310 performs a style image selecting process. The style image selecting process is a process of selecting one or more pieces of style image data to be used from among multiple pieces of style image data included in the style image data group SG. FIG. 4C shows style images SI1-SI4 as examples of a style image SI represented by the style image data. The multiple style images SI are images expressed by various styles (which may be called artistic tastes) which are different from each other. For example, a plurality of style images SI include images expressed in the style of illustrations, ink drawings, cartoons, and paintings by famous artists such as Picasso and Van Gogh.

The CPU 310 displays multiple style images SI on the UI screen, which is not shown in the figure, and receives a selection instruction input from the user to select one or more style images SI. The CPU 310 selects the style image data indicating the style image SI to be used according to the user's selection instructions. In the present embodiment, the style image data is RGB image data, similar to the content image data.

In S20, the CPU 310 performs the style converting process. FIGS. 5A and 5B illustrate the style converting process. The style converting process is performed using an image generating model GN. The image generating model GN has a configuration shown in FIG. 5B. The image generating model GN is a machine-learning model that execute a style conversion. The image generating model GN in the present embodiment is a machine-learning model disclosed in the thesis “Xun Huang and Serge Belongie. Arbitrary style transfer in real-time with adaptive instance In ICCV, 2017.”

In the image generating model GN, a data pair of content image data CD and style image data SD is input. The content image data CD is image data showing the content image CI described above. The style image data SD is image data showing the style image SI described above.

When the data pair is input, the image generating model GN performs operations using multiple parameters on the data pair to generate and output converted image data TD. The converted image data TD is image data showing the converted image TI obtained by applying the style of the style image SI to the content image CI. For example, the converted image TI is an image that has the style (painting taste) of the style image SI while maintaining the shape of the object in the content image CI. The converted image data TD is bitmap data similar to the content image data CD or the style image data SD, and in the present embodiment, the converted image data is RGB image data.

As shown in FIG. 5B, the image generating model GN includes an encoder EC, a character combiner CC, and a decoder DC.

The content image data CD and/or the style image data SD are input to the encoder EC. The encoder EC performs dimensionality reduction processing on the input image data to generate character data indicating the characteristics of the input image data. The encoder EC is, for example, a neural network (Convolutional Neural Network) with multiple layers including a convolution layer that performs a convolution process. In the present embodiment, the encoder EC uses the part of the neural network called VGG19 from the input layer to the RE1u4_1 layer. The VGG19 is a trained neural network that has been trained using image data registered in an image database called ImageNet, and the trained operational parameters are available to the public. In the present embodiment, the encoder EC uses published and trained arithmetic parameters as the arithmetic parameters of the encoder EC.

The character combiner CC is the “AdaIN layer” disclosed in the above thesis. The character combiner CC generates converted characteristic data t using the characteristic data f(c) obtained by inputting the content image data CD to the encoder EC and the characteristic data f(s) obtained by inputting the style image data SD to the encoder EC.

The decoder DC receives the converted characteristic data t. The decoder DC performs a dimensional restoration process, which is the reverse of the encoder EC process, on the converted characteristic data t using multiple operational parameters to generate the converted image data TD described above. The decoder DC is a neural network with multiple layers, including a transposed convolution layer that performs transposed convolution process.

The multiple arithmetic parameters of the decoder DC are adjusted by applying the following training. A particular number (e.g., tens of thousands) of data pairs each including the content image data CD and style image data SD for training are prepared. A single adjustment process is performed using a particular batch size of data pairs selected from these data pairs.

In one adjustment process, multiple operational parameters are adjusted according to a particular algorithm so that a loss function L, which is calculated using data pairs for the batch size, becomes smaller. As a particular algorithm, for example, an algorithm using an error backward propagation method and a gradient descent method (adam in the present embodiment) is used.

The loss function L is indicated by the following equation (1) using a content loss Lc, a style loss Ls, and a weight λ.

L=Lc+λLs (1)

The content loss Lc is, in the present embodiment, the loss (also called an “error”) between characteristic data f(g(t)) of the converted image data TD and the converted characteristic data t. The characteristic data f(g(t)) of the converted image data TD is calculated by inputting the converted image data TD, which is obtained by inputting the data pairs to be used into the image generating model GN, into the encoder EC. The converted characteristic data t is calculated by inputting the characteristic data f (c) and f (s) obtained by inputting the data pairs to be used into the encoder EC to the character combiner CC, as described above.

The style loss Ls is the loss between a group of data output from each of the multiple layers of the encoder EC when the converted image data TD is input to the encoder EC and a group of data output from each of the multiple layers of the encoder EC when the style image data SD is input to the encoder EC.

The adjustment process described above is repeatedly performed multiple times. In this way, when content image data CD and style image data SD are input, an image generating model GN is trained so that the converted image data TD, which represents the converted image obtained by applying the style of the styled image to the content image, can be output.

The style converting process (S25 in FIG. 3A) is performed using a pre-trained image generating model GN. Concretely, the CPU 310 generates the converted image data indicating the converted image TI by pairing each of the multiple style image data SD selected in S20 with the content image data CD already obtained in S10 and inputting the same into the image generating model GN. FIG. 5A shows converted images TI1 through TI4 as examples of the converted image TI. The converted images TI1 through TI4 in FIG. 5A have one-to-one correspondence with the style images SD through SI4 in FIG. 4C. The converted image TI corresponding to the style image SI is an image represented by the converted image data TD generated by inputting a pair of the style image data SD and the content image data CD indicating the style image SI into the image generating model GN. For example, if L (L being an integer greater than or equal to 1) style images SI (L being an integer greater than or equal to 1) are selected in S20, L pieces of converted image data are generated.

After the style converting process, the CPU 310 executes the automatic layout process (S30 in FIG. 3A). The automatic layout process is a process to generate M pieces of design image data using the generated converted image data and the text data indicating the text CT. The number M of generated design image data is an integer greater than or equal to 3, e.g., hundreds to tens of thousands.

FIG. 6 is a flowchart illustrating the automatic layout process. FIG. 7 illustrates the automatic layout process. In S105 of FIG. 6, the CPU 310 determines the size of the image to be printed. The size of the image to be printed (number of pixels in vertical and horizontal directions) is determined according to the print area PA (FIG. 4B).

In S110, multiple pieces of text image data are generated according to the expression information of multiple characters. The expression information is information that defines the conditions of expression for characters and includes, for example, information specifying the font, character color, background color, and character size. For example, the font is predefined fonts of k1 types. The character colors are k2 predefined colors. The background colors are k3 predefined colors. The character sizes are k4 predefined sizes. Each of the numbers k1, k2, k3, and k4 can be from three to several dozen, for example. In the embodiment, K different text image data are generated at K different representation conditions (K=k1×k2×k3×k4), which are obtained by combining these conditions. The number K of the text image data to be generated is, for example, several hundred to several thousand. FIG. 7A shows text images XI1 to XI3 as examples of text images XI shown by text image data generated from the text data showing the text CT (FIG. 4A). The text images XI1 to XI3 are images in which the text CT is expressed in various expression conditions in terms of the font, character color, and the like.

In S115, the CPU 310 adjusts each converted image TI to multiple sizes and performs trimming. In this way, adjusted image data indicating the converted images TAI after size adjustment are generated. Concretely, the CPU 310 performs an enlargement process to enlarge one converted image TI at multiple enlargement rates to generate multiple enlarged images. The CPU 310 generates adjusted image data representing the converted image TAI after size adjustment by cropping the enlarged image to the size that is set according to the print area PA. The multiple magnification rates are set to Q values, for example, 1, 1.2, 1.3, 1.5, and the like, given that the size set according to the print area PA is 1. In such a case, since Q mutually different adjusted image data are generated from one converted image data, (L×Q) mutually different adjusted image data are generated from L converted image data. FIG. 7(b) shows multiple size-adjusted converted images TAI1-TAI3 generated using the converted image TI1 as an example of a size-adjusted converted image TAI. The converted images TAI1-TAI3 after size adjustment are images in which the content image CI is expressed in various expression conditions (style, size, and the like).

In S120, the CPU 310 arranges each element image (i.e., K text images XI and (L×Q) size-adjusted converted images TAI) according to multiple pieces of layout information LT. In this way, M pieces of design image data are generated. FIG. 4D shows layout information LT1-LT3 as examples of the layout information LT. The layout information LT is information defining a layout of multiple contents. For example, the layout information LT is information that defines a character area TA where the text image XI is arranged and an image area IA where the size-adjustment converted image TAI after is arranged within the print area PA. In accordance with one layout information LT, design image data is generated for all combinations of arranging one of K text images XI and one of (L×Q) size-adjusted converted images TAI. Therefore, for one layout information LT, (K×L×Q) pieces of design image data are generated. Therefore, if it is assumed that the number of layout information LT used is P (P being an integer greater than or equal to 1, e.g., three to tens), a total of (P×K×L×Q) pieces of design image data are generated (M=P×K×L×Q). FIG. 7C shows design images DI1-DI3 generated using text image XII (FIG. 7A) and converted image TAI (FIG. 7B) after size adjustment as an example of a design image DI shown by the design image data.

In S35 of FIG. 3A, after the automatic layout process, the CPU 310 performs the design selecting process. The design selecting process is a process that uses an image identification model DN1 to determine, from among the M pieces of design image data that have already been generated, fewer than M pieces of design image data that are appropriate as candidates for printed images.

FIGS. 8A and 8B illustrate the design selecting process. FIG. 8B shows a schematic configuration of image identification models DN1 and DN2. The image identification model DN1 and the image identification model DN2, which will be discussed in detail below, have similar configurations. A known model called ResNet18 is used for each of the image identification models DN1 and DN2 in the present embodiment. This model is disclosed, for example, in the paper “K. He, X. Zhang, S. Ren, and J. Sun, “Deep residual learning for image recognition,” in ICML, 2016.

The image identification model DN1 includes an encoder ECa and a fully connected layer FC. Design image data DD is input to the encoder ECa. The encoder ECa performs the dimensionality reduction process on the design image data DD to generate characteristic data showing the characteristics of the design image DI (FIG. 7C) indicated by the design image data DD.

The encoder ECa has multiple layers (not shown). Each layer is a CNN (Convolutional Neural Network) containing multiple convolutional layers. Each convolution layer performs convolution using filters of a particular size to generate characteristic data. The calculated values of each convolution process are input to a particular activation function after a bias is added and converted. The characteristic maps output from the respective convolution layers are input to a next processing layer (e.g., the next convolution layer). The activation function is a well-known function such as the so-called ReLU (Rectified Linear Unit). The weights and biases of the filters used in the convolution process are operational parameters that are adjusted by training, as described below.

The fully connected layer FC reduces the dimensionality of the characteristic data output from the encoder ECa to produce the image evaluation data OD1. The weights and biases used in the operation of the fully connected layer FC are operational parameters that are adjusted by training as described below. The image evaluation data OD1 represents, for example, the results of classifying the design of a design image DI into multiple levels of evaluation (e.g., 3 levels of evaluation: high, medium, and low).

The image identification model DN1 is a pre-trained model that has been trained using multiple pieces of design image data for training and the corresponding teacher data for the training design image data. The design image data for training is, for example, a large number of pieces of image data obtained by executing processes S15-S30 in FIG. 3A, using content data prepared for training. Teacher data is data that represents the evaluation of the design image represented by the design image data for training. For example, an evaluator (e.g., a design expert) determines a rating for a training design image, and teacher data representing that rating is created. The image identification model DN1 is trained such that when design image data for training is input, image evaluation data OD1 is output, which shows the same evaluation results as the corresponding teacher data. The training of the image identification model DN1 is performed using a known loss function that indicates the difference between the image evaluation data OD1 and the teacher data, and a known algorithm (e.g., an algorithm using the error backward propagation method and the gradient descent method).

FIG. 8A shows a flowchart illustrating the design selecting process. In S205, the CPU 310 inputs the M pieces of design image data to the image identification model DN1 to obtain M pieces of image evaluation data OD1.

In S210, the CPU 310 deletes, from the memory, the design image data with low evaluation among the M pieces of design image data based on the image evaluation data OD1. It is assumed that the above will result in m pieces of design image data being stored in the memory (M>m). As described above, the design image data is generated by combining various representation conditions (image style and size, font and color of text, and layout information) in a brute-force fashion. For this reason, the M design images DI can might include inappropriate images that are difficult to adopt as a design. The inappropriate images include, for example, images in which the main part of the converted image TAI1 is hidden by the overlaid text image XI, or images in which the text of text image XI is unreadable because the colors of the text images XI and the converted image TAI that overlap each other are identical, and the like, which are clearly problematic as design. The design selecting process removes image data representing such inappropriate images from the M pieces of design image data. It is assumed that the number of the design image data is reduced from M to m by the design selecting process (M>m). The design selecting process is a process of selecting, independent of user input, m design images DI that may be determined as a candidate image from M design images DI using the image identification model DN1.

In S40 of FIG. 3B, after the design selecting process, the CPU 310 performs the candidate image determining process. The candidate image determining process is a process of determining N candidate images from among the m design images DI. The number N of candidate images to be determined is, for example, from 3 to 20.

FIG. 9 is a flowchart illustrating the candidate image determining process. In S300, the CPU 310 determines whether the candidate image determining process being performed is performed for the first time. When the candidate image determining process being performed is performed for the first time (S300: YES), the CPU 310 records a characteristic vector of each design image DI in the recommendation table RT (FIG. 1) in S305.

FIG. 10 shows an example of the recommendation table RT. In the recommendation table RT shown in FIG. 10, one line of data is recorded for each design image DI (for each piece of design image data). One line of data includes an image ID identifying the design image DI and a characteristic vector representing the characteristics of the design image DI identified by the image ID. The elements of the characteristic vector include the expression information, the design evaluation information, and the sum of similarities, as shown in FIG. 10.

The expression information is, for example, information representing the expression conditions of the text CT (e.g., font, character color, background color) and the expression conditions of the content image CI (e.g., size, style image used). The expression information is a vector which has values indicating these expression conditions as its elements. In FIG. 10, FONT_A, FONT_B, blue, red, and green are used as values for the font, text color, and background color elements, respectively, for ease of understanding. As an actual value for each element, an integer value greater than or equal to 1 (e.g., FONT_A=1, FONT_B=2, and so on, which are pre-assigned values for these fonts and colors) is used.

The design evaluation information is a vector of which elements are the values of multiple evaluation items. The multiple evaluation items include items that indicate the impression perceived from the design, e.g., “COOL,” “CUTE,” etc. Further, the multiple evaluation items include items related to the finish and appearance at the time of printing, for example, whether or not blotting or other defects are easily noticeable when printed on the clothes S. The value of each evaluation item is, for example, a numerical value ranging from 0 to 1, with a higher number indicating a higher evaluation. The design evaluation information is generated using the image identification model DN2 in the present embodiment.

The image identification model DN2 has the same configuration as the image identification model DN1 described above (FIG. 8B). However, the fully connected layer FC of the image identification model DN2 is configured to output image evaluation data OD2, which represents the design evaluation information as described above. The image identification model DN2 is a pre-trained model that has been trained using multiple pieces of design image data for training and the corresponding teacher data for the design image data for training. The design image data for training is, for example, a large number of pieces of image data obtained by executing processes S15-S30 in FIG. 3A, using content data prepared for training. The teacher data is data that represents the evaluation of the design images represented by the design image data for training. For example, an evaluator (e.g., a design expert) determines the ratings for the above-mentioned multiple evaluation items (e.g., “COOL,” “CUTE”) for the design images for training, and the teacher data representing the ratings are created. The image identification model DN2 is trained in such a manner that when the design image data for training is input, the image identification model DN2 outputs the image evaluation data OD2, which represents the same evaluation results as the corresponding teacher data. The training of the image identification model DN2 is performed using a known loss function that represents the difference between the image evaluation data OD2 and the teacher data, and a known algorithm (e.g., an algorithm using the error backward propagation method and the gradient descent method).

The CPU 310 generates the expression information representing the expression conditions of the text CT and the content image CI used in generating each design image data in S20-S30 of FIG. 3A as a vector, and records the vector for each design image data in the recommendation table RT. The CPU 310 inputs each design image data into the image identification model DN2 to obtain image evaluation data OD2, which indicates a vector as design evaluation information, and records the vector in the recommendation table RT for each design image data. The CPU 310 sets the sum of similarity, which is the last element of the characteristic vector, to 0, which is the initial value. As a result, the characteristic vector of each of the m pieces of design image data is recorded in the recommendation table RT in association with the image ID.

In S310, the CPU 310 randomly selects a particular number N of design images from the m pieces of design image DI (design image data), determines the design images as candidate images, and terminates the candidate image determining process. In a modification of the present embodiment, N candidate images may be determined from a particular number m2 pieces of design images with high design evaluation out of the m pieces of design images DI. As for values representing the design evaluation, the length of a vector is used, for example, as design evaluation information.

When the candidate image determining process being executed is executed for the second time or later (S300: NO), the CPU 310 determines, in S315, the N candidate images from among the m design images DI in the order of the total similarity included in the characteristic vectors, and then terminates the candidate image determining process. At the time when the second or subsequent candidate image determining process is executed, the total similarity of the respective design images DI is changed to a value different from the initial value (0) based on the image selected by the user in S51-S53, as described later. The user-selected image is an image selected by the user from among the N candidate images, as described below.

In S45 of FIG. 3B, after the candidate image determining process, the CPU 310 displays the selection screen WI1, which includes the N candidate images determined in the previously performed candidate image determining process, on the display 370. FIGS. 11A and 11B show examples of a UI screen. FIG. 11A shows an example of the selection screen WI1. The selection screen WI1 includes N (6 in the example in FIG. 11A) design images DIa to −DIf as candidate images. The selection screen WI1 further includes a message MS1 that prompts the user to select a preferred image from the displayed candidate images (i.e., the design images DIa to DIf), an OK button BT, and a selection frame SF.

In S50, the CPU 310 obtains an instruction by the user to select a preferred candidate image. For example, the user may select one design image by operating the selection frame SF, and then click the OK button BT. When the OK button BT is clicked, the CPU 310 obtains a selection instruction to select the candidate image that is selected with the selection frame SF at that time. In the following description, the candidate image selected by the selection instruction will also be referred to as the user-selected image.

In S51, the CPU 310 calculates the similarity between the user-selected image and each of the m design images DI. In the present embodiment, the similarity is calculated using the characteristic vector (FIG. 10) of the design image DI recorded in the recommendation table RT. Concretely, the similarity between two images is a cosine similarity cos θ between the characteristic vector Va of one image and the characteristic vector Vb of the other image. The cosine similarity cos θ is a value representing the degree to which two characteristic vectors are similar, and is obtained by dividing the inner product of the two characteristic vectors (Va·Vb) by the product of the lengths of the two vectors (L2 norm) (|Va|·|Vb|).

In S52, the CPU 310 adds the calculated similarity to the total of the similarities of the respective design images. Concretely, the CPU 310 adds the similarity of each design image DI calculated in S51 to the sum of the similarities of (m−1) design images DI, excluding the user-selected image, out of the m design images DI recorded in the recommendation table RT. In this way, the total of the similarities of the respective design images DI recorded in the recommendation table RT is updated.

In S53, the CPU 310 adds 1 to the total of the similarities of the user-selected images. Concretely, the CPU 310 adds “1,” which is the maximum value of the cosine similarity cos θ, to the total of the similarities of the user-selected images among the m design images DI recorded in the recommendation table RT. In this way, as the sum of the similarities, which is one element of the characteristic vector, is updated, the similarity with the currently selected image is reflected in the determination of next and subsequent candidate images.

In S55, the CPU 310 determines whether the number of repetitions of the process from S40 to S50 is equal to or greater than a threshold THn. When the number of repetitions is less than the threshold THn (S55: NO), the CPU 310 returns the process to S40. When the number of repetitions is greater than or equal to the threshold THn (S55: YES), the CPU 310 proceeds to S57.

In S57, the CPU 310 displays the input screen WI2 for the final determination instruction. FIG. 11B shows an example of the input screen WI2. The input screen WI2 includes the selected image DIx selected by the selection instruction obtained in the previously executed S50. The input screen WI2 further includes a message MS2 that prompts the user to approve or disapprove the selected image DIx as an image to be printed finally, an approval button BTy, and a disapproval button BTn.

In S60, the CPU 310 determines whether the final determination instruction has been obtained. When the user wants to make the selected image DIx included in the input screen WI2 the final image to be printed, the user clicks on the approval button BTy, while when the user does not want the selected image DIx to be the final image to be printed, the user clicks on the disapproval button BTn. When an indication to continue selecting a print image is obtained (S60: NO), the CPU 310 returns the process to S40. When the final determination instruction is obtained (S60: YES), the CPU 310 proceeds to S70.

In S70, the CPU 310 generates print data to print the print image determined by the final determination instruction (e.g., the design image DIx in FIG. 11B). Concretely, the CPU 310 executes a particular generation process on the design image data representing the design image DI that is finally determined as the image to be printed, and generates the print data. The generation process includes, for example, an image quality adjustment process, a color conversion process, and a halftone process.

The image quality adjustment process is a process to improve the appearance of an image to be printed on the clothes S. Since the image to be printed on the clothes S is prone to blotting, the image quality adjustment process includes a process to suppress the deterioration of image quality caused by blotting, for example, by providing an area of a particular color (e.g., white) around the text. The image quality adjustment process includes a process to increase the resolution of an image to be printed, for example, a process of increasing the resolution of an image using a machine learning model including a Convolutional Neural Network (CNN).

The color conversion process converts RGB image data into image data that represents the color of each pixel by means of color values that include multiple component values corresponding to the multiple color materials used for printing. In the present embodiment, the RGB value of each pixel in the design image data that has already undergone the image quality adjustment process is converted to CMYK values containing the four component values, e.g., C (cyan), M (magenta), Y (yellow) and K (black) values. The color conversion process is executed with reference to a color conversion profile (not shown) stored in advance in the non-volatile storage device 320. The halftone process is a process of converting design image data after the color conversion process into print data (also called dot data) that represents the state of dot formation for each pixel and for each color material.

In S75, the CPU 310 transmits the generated print data to the printer 200. When the printer 200 receives the print data, the CPU 210 of the printer 200 controls the printing mechanism 100 to print the image to be printed on the clothes S according to the print data.

In S80, the CPU 310 performs the style image updating process and terminates the printing process. FIGS. 12A-12C illustrate the style image updating process. The style image updating process is a process of replacing some of the multiple pieces of style image data in the style image data group SG based on the evaluation of the style image data.

FIG. 12A is a flowchart illustrating the style image updating process. In S402, the CPU 310 updates the style image evaluation table ST (see FIG. 1). FIG. 12B shows an example of the style image evaluation table ST. In the style image evaluation table ST, the evaluation values of respective ones of the multiple pieces of style image data included in the style image data group SG are recorded in association with the images ID that identify the style image data.

In the present embodiment, the initial value of the style image data evaluation value is 0. In the present embodiment, the evaluation value of the style image data is updated based on the result of the user's selection of the style image SI and the user's selection of the candidate image. For example, in the style image selecting process (S20 in FIG. 3A), one point is added to the evaluation value of the style image SI selected by the user. One point is added to the evaluation value of the style image SI used to create the candidate image selected by the user (design image DI) in S50 of FIG. 3B. Two points are added to the evaluation value of the style image SI used to create the design image DI, which was determined by the user as the final image to be printed in S57 and S60 in FIG. 3B. The above-described evaluation method is an example and may be modified as appropriate. For example, only the style image SI used to create the design image DI determined by the user as the image to be finally printed may be subject to the addition of evaluation values, or only the style image SI used to create the candidate image (design image DI) selected by the user in S50 may be subject to the addition of evaluation values.

In S405, the CPU 310 determines whether the number of printed sheets since the last update of the style image data is greater than or equal to the threshold THc. The threshold THc for the number of printed sheets is, for example, tens to hundreds of sheets. When the number of printed sheets after the last update of the style image data is less than the threshold THc (S405: NO), the CPU 310 terminates the process without updating the style image data. When the number of printed sheets after the last update of the style image data is equal to or greater than the threshold THc (S405: YES), the CPU 310 proceeds to S410.

In S410, the CPU 310 refers to the style image evaluation table ST to determine whether there is a low evaluation style image SI. For example, a style image SI of which the evaluation value is less than the threshold THs is determined to be a low evaluation style image. When there is no low evaluation style image SI (S410: NO), the CPU 310 terminates the process without updating the style image data. When there is a low evaluation style image SI (S410: YES), the CPU 310 executes S415 and S420 to update the style image data.

In S415, the CPU 310 deletes the low evaluation style image data among the multiple pieces of style image data included in the style image data group SG. In S420, the CPU 310 generates new style image data by combining high evaluation style image data. For example, the CPU 310 randomly selects, from among the remaining style image data, two style image data representing style image SI of which the evaluation value is greater than or equal to the threshold THh. The CPU 310 combines the two style image data to generate new style image data. Composition of style image data is performed, for example, by taking an average value (V1+V2)/2 of the value V1 of each pixel in one style image and the value V1 of a pixel at the same coordinate in the other style image as the value of a pixel at the same coordinate in the new style image. FIG. 12C illustrates a new style image SI12 obtained by combining the style images SI1 and SI2 of FIG. 4C. The CPU 310 generates the same number of new style image data as the number of style image data deleted in S415. The new style image data is stored in the non-volatile storage device 320. When the style image updating process is completed, the printing process shown in FIGS. 3A and 3B is terminated.

According to the present embodiment described above, the CPU 310 determines the print image to be printed (S10-S60 in FIGS. 3A and 3B), generates print data representing the determined print image (S70 in FIG. 3B), and causes the printer 200 as the print engine to execute printing according to the print data (S75 in FIG. 3B). When determining the print image, the CPU 310 displays the candidate images (design images DIa-DIf in FIG. 11A), which are candidates for the image to be printed, on the display 370 (S45 in FIG. 3B, FIG. 11A). The CPU 310 obtains a selection instruction to select a preferred image from the N candidate images displayed on the display 370 (S50 in FIG. 3B). Since this selection instruction indicates that the user's evaluation of the selected candidate image is higher than the user's evaluation of other candidate images, it can be said that this selection instruction is information indicating the evaluation of the candidate image displayed on the display 370 and is information based on user input. The CPU 310 performs the display of such candidate images and the obtaining of selection instructions multiple times (S55 in FIG. 3B).

When displaying candidate images for the second and subsequent times, the CPU 310 determines the candidate images to be displayed based on the selection instructions (S40, S51-S53 in FIG. 3B, S315 in FIG. 9) and displays the determined candidate images on the display 370 (S45 in FIG. 3B). The CPU 310 determines the image to be printed based on the candidate images displayed on the display 370 and the selection instructions that are obtained. Concretely, the image selected by the user's selection instructions from among the N candidate images finally displayed on the display 370 is determined as the image to be printed (S50, S55-S60 in FIG. 3B). According to this configuration, the display of candidate images and the obtaining of selection instructions can be performed multiple times, so that candidate images that match the user's preferences can be displayed. The image to be printed is then determined based on the plurality of displayed candidate images and the obtained selection instructions. Therefore, based on the user's input, an image that matches the user's preference can be simply determined and printed by the printer 200. When users (e.g., a salesperson clerks or customers) design and create images to be printed by themselves, a relatively high level of knowledge and skill in design is required of the user. The use of pre-prepared templates, for example, can reduce the burden on the user, but users are required to have a certain level of knowledge and skill. According to the present embodiment, when the user prepares content data such as text and images in advance, the user can realize the printing of the desired image by simply repeating the selection of the desired image from the candidate images (design images DI).

Further, according to the above embodiment, the CPU 310 obtains one or more content data (S10 in FIG. 3A). Then, the CPU 310 generates multiple design image data (S25, S30 in FIG. 3A, S110-S120 in FIG. 6) representing multiple design images DI in which the content is expressed using the multiple pieces of expression information (e.g., character font, character color, style image data, image size, and layout pattern) defining the expression of the content, and the content data. The CPU 310 displays the candidate image on the display 370 using at least one of the multiple pieces of design image data. As a result, a design image DI that expresses the content in various forms using the content data and multiple pieces of expression information can be displayed on the display 370 as a candidate image.

Further, according to the above embodiment, the content data includes content image data representing the content image CI and text data representing the text CT. As a result, a variety of design images DI, which are combinations of text CT and content images CI, such as photographs and computer graphics, can be displayed on the display 370 as candidate images. Furthermore, according to the above embodiment, the CPU 310 generates the design image data representing the design image DI (FIG. 7C), in which the size-adjusted converted image TAI (FIG. 7B) representing the content image CI, and the text image XI (FIG. 7A) expressing the text CT, are arranged in accordance with the layout defined by the layout information. As a result, a design image DI with multiple contents (in the present embodiment, text and images) arranged in various layouts can be displayed on the display 370 as a candidate image.

Further, according to the above embodiment, the CPU 310 executes the style converting process using the style image data on the content image data to generate converted image data (S25 of FIG. 3A) representing the converted image TI (FIG. 5A) expressing the content image CI in a particular style. The CPU 310 uses the converted image data to generate the design image data representing the design image DI including the converted image (concretely, the size-adjusted converted image TAI) (S30 in FIG. 3A, S115, S120 in FIG. 6, FIG. 7B, C). As a result, by using the style converting process, the design image data representing the design image DI in which the content image CI is expressed in various styles can be generated.

Further, according to the above embodiment, the CPU 310 obtains the style evaluation information, which is information about the evaluation of the style image data and is based on the user's input. Concretely, as described above in the description of the style image updating process (FIG. 3B), the result of the user's selection of the style image SI (S20) and the result of the user's selection of the candidate image (S50) are used as the style evaluation information. Based on the style evaluation information, the CPU 310 executes the style image updating process, which is a process of changing at least a part of the style image data to be used in the style converting process (FIG. 3A, S 80, FIG. 12). As a result, at least part of the style image data to be used in the style converting process is changed based on the style evaluation information, thus increasing the possibility that the style converting process using style image data corresponding to the user's evaluation is executed.

Further, according to the above embodiment, the CPU 310 generates another style image data to be used in the style conversion process (S420 in FIG. 12A, FIG. 12C) by combining multiple pieces of style image data of which the evaluation based on the style evaluation information is higher than the standard, concretely, two pieces of style image data representing style images SI of which the evaluation values are higher than the threshold THh, as described above. As a result, appropriate style image data can be newly generated based on the user's evaluation. Thus, it is further possible to generate design image data representing a variety of candidate images (design images DI) preferred by the user.

Furthermore, according to the above embodiment, the CPU 310 obtains the image evaluation information representing evaluations of the candidate images (concretely, a selection instruction to select a preferred image from among the N candidate images displayed on the display 370 as described above). This image evaluation information is used not only to evaluate the candidate image data, but also as style evaluation information that represents the evaluation of the style image data used to generate the candidate image data. As a result, a single input by the user is used to evaluate both the candidate image data and the style image data, thereby reducing the burden on the user to input the evaluation for the style image data.

Further, according to the above embodiment, the CPU 310 determines less-than-m candidate images (N in the present embodiment) from among the m design images DI (S310 in FIG. 9) and displays the determined less-than-m candidate images on the display 370 (S40, S45 in FIG. 3B, FIG. 9). In the second and subsequent displays of the candidate images, the CPU 310 uses the image evaluation information (concretely, the selection instruction to select a preferred image from the N candidate images displayed on the display 370 described above) that is obtained immediately before to calculate the evaluation values for the m design images DI (in the present embodiment, the cosine similarity cos with the user-selected image) (S51 in FIG. 3B). The CPU 310 determines less-than-m candidate images again from among the m design images DI based on the evaluation values (S52, S53 in FIG. 3,B S315 in FIG. 9), and displays the determined less-than-m candidate images on the display 370 (S40, S45 in FIG. 3B). As a result, candidate images can be determined according to the user's preferences based on the evaluation values reflecting the evaluation by the user, so that the user can finally print a print image that matches the user's preferences.

More concretely, the CPU 310 calculates the similarity of the characteristic vectors including expression information representing the expression conditions of characters and images in the design image DI and design evaluation information representing the evaluation of the design, the similarity between the m design images DI and the user-selected images (S51 in FIG. 3B) is calculated using the cosine similarity cos θ. Based on the similarity, the CPU 310 determines a design image DI that has a high similarity to the user-selected image as a candidate image to be displayed (S315 in FIG. 9). As a result, the design image DI with high similarity to the user-selected image can be appropriately determined as the candidate image.

More concretely, the characteristic vector used to calculate the cosine similarity cos θ contains the sum of similarities as elements (FIG. 10). Then, the CPU 310 updates the sum of the similarities each time a candidate image is displayed and a selection instruction for a user-selected image is obtained (S51-S53 in FIG. 3B). The CPU 310 then determines N candidate images from among the m design images DI in the descending order of the sum of the similarities (S315 in FIG. 9). As a result, since the results of multiple selections of user-selected images by the user are reflected in the sum of similarities of the characteristic vectors, the possibility that a design image DI that matches the user's preferences is finally determined as a candidate image can be increased.

Further, the CPU 310 selects m design images DI from among M design images DI (M being an integer greater than or equal to 3) by performing the design selecting process (S35 in FIG. 3A, FIG. 8), which is independent of user input. The CPU 310 determines less than m candidate images (N in the present embodiment) to be displayed from among the m selected design images DI. As a result, for example, images with inappropriate designs as print images can be excluded in advance, thus it is possible to suppress the display of inappropriate images as candidate images.

Concretely, the design selecting process is a process that uses the image identification model DN1, which is a machine learning model trained to output image evaluation data OD1 representing the results of evaluating the design image DI when design image data is input, to obtain the image evaluation data OD1 of the m images and to screen the m images based on the image evaluation data OD1 of the m images (FIG. 8). As a result, the selecting process using the image identification model DN1 can easily suppress the display of inappropriate images as candidate images without relying on user input.

In a modified embodiment, the contents of the style image updating process are different from those in the above-described embodiment. Configurations of the other components of the modified embodiment are the same as those of the above-described embodiment.

FIG. 13 is a flowchart illustrating a style image updating process according to the modified embodiment. In S400B, the CPU 310 displays an evaluation input screen WI3 on the display 370 to obtain evaluation information of the style image SI from the user. FIG. 14 shows an example of the evaluation input screen WI3. The evaluation input screen WI3 shown in FIG. 14 includes the converted images TI1-TI14 (FIG. 5A) represented by the converted image data generated in the style converting process in S25 of FIG. 3A. The evaluation input screen WI3 further includes radio buttons RB1-RB4, which are UI elements for inputting the user's evaluations of the converted images TI1-TI4, respectively. The user can enter one of three ratings (high (good), medium (normal), or low (bad)) for the converted images via radio buttons RB1 to RB4, respectively. The evaluation input screen WI3 further includes a message MS3, which prompts the user to enter an evaluation of the converted images TI1 to TI4, and an OK button BT. Instead of being executed at this timing, the process of S400B may be executed at another timing, for example, after the style converting process (S25) in FIG. 3A and before the automatic layout process (S30). In such a case, the CPU 310 may generate design image data representing the design image DI in the automatic layout process in S30, using only the converted images TI with high and medium evaluations, without using the converted images TI with low evaluations.

The user clicks the OK button BT with the radio buttons RB1 to RB4 on the evaluation input screen WI3 checked. When the OK button BT is clicked, the CPU 310 obtains the information indicating the evaluation checked by any of the radio buttons RB1 to RB4 at that time as the evaluation information for the converted images TI1 to TI4.

In S402B, the CPU 310 updates the style image evaluation table ST (FIG. 1, FIG. 12B). In the style image evaluation table ST in FIG. 12B, as described above, the evaluation values of respective pieces of style image data included in the style image data group SG are recorded in association with the images ID that identify the style image data.

In the present embodiment, the initial value of the evaluation value of the style image data is 0. In the present embodiment, the evaluation value is updated based on the evaluation information of the style image SI by the user obtained via the evaluation input screen WI3. For example, one point is added to the evaluation value of a style image SI for which the evaluation information indicating a high evaluation (good) is obtained. Further, the evaluation value of the style image SI for which the evaluation information indicating medium evaluation (normal) has been obtained is not changed. One point is subtracted from the evaluation value of the style image SI for which the evaluation information indicating low evaluation (bad) is obtained. This evaluation method is an example and may be modified as appropriate. For example, instead of evaluation information indicating a three-level rating, evaluation information indicating a five-level or seven-level rating may be obtained. In such a case, subtraction or addition of evaluation values is performed as appropriate according to the five- or seven-step evaluation.

In 5405B, similar to S405 in FIG. 12A, the CPU 310 determines whether the number of sheets printed since the last style image data update is greater than or equal to the threshold THc. When the number of sheets printed after the last update of the style image data is less than the threshold THc (5405B: NO), the CPU 310 terminates the process without updating the style image data. When the number of sheets printed after the last style image data update is equal to or greater than the threshold THc (5405B: YES), the CPU 310 proceeds to S410B.

In S410B, the CPU 310 refers to the style image evaluation table ST to determine whether there is a low evaluation style image SI. For example, a style image SI for which the evaluation value is less than a threshold THsb is considered to be a low evaluation style image. The threshold THsb is set to a particular negative value in the modified embodiment. When there is no low evaluation style image SI (S410B: NO), the CPU 310 terminates the process without updating the style image data. When there is a low evaluation style image SI (S410B: YES), the CPU 310 executes S415B and S420B to update the style image data.

In S415B, the CPU 310 deletes the low evaluation style image data among the multiple pieces of style image data in the style image data group SG. In S420B, the CPU 310 transmits a request to add new style image data to the administrative user (e.g., a store clerk) managing the print system 1000, and terminates the style image updating process. The request for addition of the new style image data is transmitted, for example, to the e-mail address of the administrative user who has been registered with the terminal device 300 in advance. Upon receiving the request for the addition, the administrative user, for example, prepares new style image data and stores the new style image data in a particular folder where the style image data group SG is stored. In this way, the multiple pieces of style image data stored in the non-volatile storage device 320 of the terminal device 300 are updated. It should be noted that the deletion of the low evaluation style image data in S415B may be performed after the new style image data is stored in the non-volatile storage device 320 by the administrative user.

According to the modified embodiment described above, a direct evaluation of the style image SI can be obtained from the user via the evaluation input screen WI3. Therefore, the style image data can be updated based on a more accurate determination of the user's evaluation of the style image SI. Further, in the present embodiment, new style image data is prepared by the administrative user, so that, for example, it is expected that new style image data that is significantly different from the existing style image data will be added.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

(1) In each of the above embodiment and modified embodiment, clothes S are exemplified as the printing medium, but the printing medium is not necessarily limited to the clothes. The printing media may be other fabric products, concretely, such as cases for bags, wallets, pants, cell phones, and other products. Further, the printing media is not necessarily limited to fabric products, but can also be the above products created using other materials such as leather, paper, plastic, metal, and the like. Furthermore, the printing medium is not necessarily limited to the finished product described above, but may be, for example, a component, semi-finished product, or material (e.g., fabric, leather, paper, or plastic or metal plate before processing) used to create the product. Furthermore, the printing media may be poster paper.

(2) In the above embodiment and modified embodiment, the content data (text data and image data) is prepared by the user. The content data is not necessarily limited to one prepared by the user, but may be selected from a set of content data that has been prepared in advance by the seller of the print system 1000 and stored in the non-volatile storage device 320.

(3) In the above embodiment and modified embodiment, multiple converted images TI are generated from one content image CI, and a design image DI is generated using the multiple converted images TI. Similarly, from one text CT, multiple text images XI are generated, and a design image DI is generated using the multiple text images XI. Alternatively, some content images specified by the user, for example, may be arranged in the design image DI, for example, as is. Further, in the above embodiment and modified embodiment, the number of contents used to generate one design image DI is two (i.e., text CT and content image CI), but the number of contents can be one, three or more. Furthermore, the content used may be only the text or only the images, such as photos or computer graphics.

(4) In the above embodiment and modified embodiment, a design image DI including images expressing the content image CI in various forms is generated by executing a style converting process using multiple pieces of style image data for one content image data. Not limited to the above, instead of or together with the style converting process, other image processing, such as color number reduction, edge enhancement, compositing with other images, and the like, may be used to generate a design image DI that includes images representing the content image CI in various forms.

In the above embodiment and modified embodiment, a single text CT is represented by multiple representation conditions (font, character color, and the like) to generate a design image DI that includes images representing the text CT in various forms. These expression conditions are examples, and a variety of expression conditions can be used. For example, by executing the style converting process similar to the content image CI on the image data showing text CT, a design image DI containing images representing the text CT in various forms may be generated.

(5) In the above embodiment and modified embodiment, a selection instruction to select one preferred image from the N candidate images (design images DIa-DIf) displayed on the display 370 is obtained as image evaluation information indicating the evaluation of the N candidate images. The image evaluation information is not necessarily limited to the above, but may be different from the selection instructions for selecting the preferred image. For example, the user may rank the N candidate images in order of preference, and the CPU 310 may obtain information indicating the order as image evaluation information. In such a case, for example, the CPU 310 may calculate the similarity between each of the particular number of candidate images with the highest ranking and the design image DI to be evaluated, and add the similarity multiplied by the weight according to the ranking as the evaluation value of the design image DI to be evaluated. Alternatively, the user may assign a multi-level (e.g., 3 or 5-level) evaluation to the N candidate images according to the degree of preference, and the CPU 310 may obtain information indicating this evaluation as image evaluation information. In such a case, for example, the CPU 310 may calculate the evaluation value of the design image DI to be evaluated so that the higher the similarity to the candidate image, the higher the evaluation by the user.

(6) In the above embodiment and modified embodiment, the selected image is determined as the print image when the final determination instruction is obtained from the user for the selected image that was last selected by the user. Methods for determining the final printed image are not necessarily limited to the above. For example, after displaying N candidate images and obtaining selection instructions to select one image from the N candidate images for a particular number of times, the CPU 310 may display the plurality of selected images selected by the selection instructions for the last particular number of times and select one print image from the plurality of selected images. In general, it is preferred that the image to be finally printed be determined based on at least part of the multiple candidate images displayed in the display of candidate images performed over a plurality of times and at least part the selection instructions obtained over multiple times.

(7) The printing process in FIGS. 3A and 3B of the above embodiment is an example, and may be modified or omitted as appropriate. For example, in the above embodiment and modified embodiment, the expression information representing the expression conditions for generating M design images DI includes font, character color, background color, character size, style image data indicating the style applied to the content image, and image size, layout information, and the like. The above expression information may be modified or omitted as appropriate.

The style image updating process (S80) and/or the design selecting process (S35) in FIG. 3A may be omitted.

(8) In the above embodiment and modified embodiment, the cosine similarity cos θ of the characteristic vectors of the two images is used as the similarity between the user-selected image and the design image DI to be evaluated. Instead, the similarity calculated using other methods, such as the similarity of histograms of two images or the similarity obtained by comparing two images pixel-by-pixel or region-by-region, may be used.

The characteristic vector of the image in the above embodiment and modified embodiment is an example and is not necessarily limited to the above. For example, the characteristic vector may include the vector indicating the expression information and may not include the vector indicating the design evaluation information. Alternatively, the characteristic vector may include a vector indicating design evaluation information and may not include a vector indicating design evaluation information.

In the above embodiment and modified embodiment, the algorism for determining the N candidate images to be displayed for the second and subsequent times is an example and is not necessarily limited to the above. For example, in addition to considering the similarity between the user-selected image and the design image DI to be evaluated, similarity to printed images printed by other users in the past may be considered. When another user is printing a print image similar to the user-selected image, the evaluation value may be calculated so that a design image DI generated using the same or similar expression information (e.g., character font and style image data) used to generate the multiple print images printed by the other user is preferentially selected as a candidate image. The evaluation value may be calculated so that the design image DI generated using the same or similar expression information (e.g., character font and style image data) used to generate the plurality of printed images printed by the other user is preferentially selected as a candidate image.

(9) The device that executes all or part of the printing process of FIGS. 3A and 3B may be various other devices instead of the terminal device 300. For example, the CPU 210 of the printer 200 may perform the printing process of FIGS. 3A and 3B. In such a case, the terminal device 300 is not necessary, and the CPU 210 of the printer 200 generates the print data and causes the printing mechanism 100 as a print execution device to print the printed image. Further, the device that executes the printing process in FIGS. 3A and 3B may be a server or the terminal device 300 connected to the printer 200 via the Internet. In such a case, the server may be a so-called cloud server including multiple computers that can communicate with each other.

(10) In each of the above embodiment and modified embodiment, a part of the configuration realized by hardware may be replaced with software, or conversely, a part or all of the configuration realized by software may be replaced with hardware.

The above description of the present disclosures based on embodiment and modifications is intended to facilitate understanding of the aspects of the present disclosures and is not intended to limit the same. The configurations described above may be changed and improved without departing from aspects of the present disclosures, and the inventions set forth in the claims include equivalents thereof

What is claimed is:

1. A non-transitory computer-readable recording medium for an image processing device which includes a computer, the non-transitory computer-readable recording medium containing computer-executable instructions, the instructions causing, when executed by the computer, the image processing device to perform:
a print image determining process of determining a print image to be printed;
a print data generating process of generating print data indicating the determined print image; and
a print controlling process of causing a print engine to execute printing according to the print data,
wherein, in the print image determining process, the image processing device performs, multiple times:
a candidate displaying process of displaying one or more candidate images on a display, each of the one or more candidate images being a candidate of the print image; and
an evaluation obtaining process of obtaining image evaluation information representing evaluation of each of the one or more candidate images displayed on the display, the image evaluation information being information based on a user input,
wherein the candidate displaying process performed a second time or later is a process of determining the one or more candidate images based on the image evaluation information and displaying the determined one or more candidate images on the display, and
wherein the print image determining process determines the print image based on at least part of multiple candidate images displayed in the candidate displaying process performed over multiple times and at least part of multiple pieces of the image evaluation information obtained in the evaluation obtaining process performed over multiple times.

2. The non-transitory computer-readable recording medium according to claim 1, the instructions further causing, when executed by the computer, the image processing device to perform:
a content obtaining process of obtaining one or more pieces of content data indicating a content;
an expression information obtaining process of obtaining the content data and the multiple pieces of expression information; and
a candidate image generating process of generating multiple pieces of candidate image data indicating the multiple candidate images, respectively, with using the content data and the multiple pieces of expression information,
wherein the candidate displaying process is a process of displaying the multiple candidate images on the display with using the multiple pieces of candidate image data, respectively.

3. The non-transitory computer-readable recording medium according to claim 2,
wherein the content data includes at least one of image data indicating an image as the content or text data indicating text as the content.

4. The non-transitory computer-readable recording medium according to claim 3,
wherein the content data includes first content data indicating a first content and second content data indicating a second content,
wherein the expression information includes layout information defining a layout of multiple contents, and
wherein the candidate image generating process generates the candidate image data indicating the candidate image in which a first content image expressing the first content and a second content image expressing the second content arranged according to the layout defined by the layout information.

5. The non-transitory computer-readable recording medium according to claim 2,
wherein the expression information includes style image data indicating a style image expressed in a particular style,
wherein, in the candidate image generating process, the image processing device executes a style converting process using the style image data to generate converted image data indicating a converted image in which the content is represented in the particular style.

6. The non-transitory computer-readable recording medium according to claim 5,
wherein, in the candidate image generating process, the image processing device performs:
the style converting process multiple times using the multiple pieces of the style image data different from each other with respect to single content data to generate multiple pieces of the converted image data indicating multiple converted images, respectively; and
generating multiple pieces of the candidate image data using the multiple pieces of the converted image data, and
wherein the instructions further causing, when executed by the computer, the image processing device to perform:
a style evaluation obtaining process of obtaining style evaluation information on evaluation of the style image data, the style evaluation information being information based on user input; and
a style changing process of changing at least a part of the style image data to be used in the style converting process based on the style evaluation information.

7. The non-transitory computer-readable recording medium according to claim 5,
wherein, in the style converting process, the image processing device generates another style image data to be used in the style converting process by combining multiple pieces of style image data of which evaluation based on the style evaluation information is higher than standard.

8. The non-transitory computer-readable recording medium according to claim 6,
wherein, in the style evaluation obtaining process, the image processing device obtains the image evaluation information indicating evaluation of the candidate image as the style evaluation information indicating evaluation of the style image data used to generate the candidate image data.

9. The non-transitory computer-readable recording medium according to claim 1,
wherein the candidate displaying process is a process of determining less-than-m candidate images from among m images and displaying the determined less-than-m candidate images on the display, the m being an integer greater than or equal to 2,
wherein the candidate displaying process performed a second time or later is a process of:
calculating an evaluation value for at least part of the m images using the image evaluation information obtained in the evaluation obtaining process previously performed;
determining less-than-m candidate images from among the m images again using the evaluation value; and
displaying the determined less-than-m candidate images on the display.

10. The non-transitory computer-readable recording medium according to claim 1,
wherein the candidate displaying process is a process of:
selecting m candidate images from among M images by executing a particular selecting process independent of user input, the M being an integer greater than or equal to 3, m being an integer greater than or equal to 2 and less than M;
determining less-than-m candidate images from among the selected m images; and
displaying the determined less-than-m candidate images on the display.

11. The non-transitory computer-readable recording medium according to claim 10,
wherein the particular selecting process is a process of:
obtaining evaluation data of the M images by using a machine learning model trained to output the evaluation data representing a result of evaluating an image indicated by an image data when the image data is input; and
selecting the m image based on the evaluation data of the obtained M images.

12. An image processing device comprising:
a print engine configured to print an image; and
a controller configured to perform:
a print image determining process of determining a print image to be printed;
a print data generating process of generating print data indicating the determined print image; and
a print controlling process of causing the print engine to execute printing according to the print data,
wherein, in the print image determining process, the controller performs, multiple times:
a candidate displaying process of displaying one or more candidate images on a display, each of the one or more candidate images being a candidate of the print image; and
an evaluation obtaining process of obtaining image evaluation information representing evaluation of each of the one or more candidate images displayed on the display, the image evaluation information being information based on a user input,
wherein the candidate displaying process performed a second time or later is a process of determining the one or more candidate images based on the image evaluation information and displaying the determined one or more candidate images on the display, and
wherein, in the print image determining process, the controller determines the print image based on at least part of multiple candidate images displayed in the candidate displaying process performed over multiple times and at least part of multiple pieces of the image evaluation information obtained in the evaluation obtaining process performed over multiple times.
